(19) United States
(12) Patent Application Publication
(10) Pub. No.: US 2026/0327436 A1
(43) Pub. Date: Oct. 22, 2026

(54) POWDER MIXTURE FOR TEFLON-FREE NON-STICK COATING

(71) Applicant: ACS COATING SYSTEMS GMBH, Wilhelmshaven (DE)

(72) Inventor: Christoph STECHER, Wilhelmshaven (DE)

(21) Appl. No.: 19/105,781

(22) PCT Filed: Aug. 22, 2023
(86) PCT No.: PCT/EP2023/073027

§ 371 Date: Feb. 21, 2025

(30) Foreign Application Priority Data
Aug. 23, 2022 (DE) 10 2022 121 273.4

(51) Int. Cl. C09D 5/16; A47J 36/02; C09D 171/00

(52) U.S. Cl. CPC C09D 5/1662; A47J 36/025; C09D 171/00

(57) ABSTRACT

The invention relates to a powder mixture, dry or as a dispersion in a liquid, comprising powder particles of at least one polyaryletherketone (PAEK) polymer and optionally polyphenylene sulfide (PPS) polymer, wherein the powder mixture can be prepared without the addition of fluorine or fluorine-containing compounds. Preferably, the powder mixture comprises at most 1000 ppb, preferably at most 100 ppb, more preferably at most 25 ppb total fluorides, measured by combustion ion chromatography (TOF-CIC). In addition, the invention relates to a method for coating an article, in particular cookware and bakeware, using the powder mixture, the use of the powder mixture to achieve a technical effect selected from non-stick effect and corrosion protection, and an article coated by the method.

The present invention relates to a powder mixture for a Teflon-free non-stick coating, a method for coating an object, in particular cookware and bakeware, using the powder mixture, the use of the powder mixture to achieve a non-stick and sliding effect on an object, particularly on cookware and bakeware, and an object coated by the method, especially cookware and bakeware.

State-of-the-art PTFE coatings are typically applied as a three-layer system for high-quality cookware, i.e., in three layers with at least two firing processes. Initially, a base layer, usually consisting of a binder resin dissolved in a solvent, such as PAI dissolved in NMP, is wet-sprayed, dried, and pre-crosslinked. Subsequently, a transition layer and a topcoat are applied wet-on-wet, where the topcoat mainly contains fluoropolymer, typically PTFE. The entire coating is then baked at approximately 420° C. for about 10 minutes. These coatings can be modified with pigments and various fillers. However, the disadvantages include the use of fluoropolymers and the fact that the baking temperature is significantly higher than the decomposition temperature of PTFE, which can lead to the formation of potentially harmful substances (PFAS). Additionally, these coatings may release toxic substances (PFAS) at high temperatures during use.

Moreover, so-called ceramic SolGel coatings, which achieve the non-stick effect through the inclusion of silicones, are known. However, these coatings are often brittle and not durable.

According to an EU regulation, the threshold for PFAS in the EU is to be significantly lowered starting in 2024, which means that PTFE coatings (“Teflon”) must be replaced as non-stick coatings from today's perspective.

The object of the present invention is to provide a universally applicable coating for objects, especially for cookware and bakeware, without fluoropolymers and without the addition of fluorine.

The above object is achieved by providing a powder mixture according to Claim 1, a method according to Claim 8, a use according to Claim 10, and an object, particularly cookware and bakeware, according to Claim 12 or 13. Preferred embodiments are described in the dependent claims. The term cookware and bakeware, as used in the invention, includes any object suitable in shape for holding food and subsequently cooking or baking. Therefore, in addition to pans, baking trays, baking molds, etc., as well as grill trays, grill containers, and grill grates, are covered by this definition.

In a first aspect of the invention, a powder mixture, either dry or as a dispersion in a liquid, is provided, which comprises powder particles made of at least one polyaryletherketone (PAEK) polymer and optionally polyphenylene sulfide (PPS) polymer.

The powder mixture according to the invention can be produced without the addition of fluorine or fluorine-containing compounds. This is particularly ensured if the powder mixture does not exceed certain limits for total fluoride content after combustion at 900° C.-1000° C. in a humid, oxygen-rich atmosphere. Preferably, the powder mixture contains at most 1000 ppb, preferably at most 100 ppb, and particularly preferably at most 25 ppb total fluoride, measured by combustion ion chromatography (TOF-CIC).

The object of the present invention is providing a universally applicable coating for articles, in particular for cookware and bakeware, without fluoropolymers and without the addition of fluorine.

The above task is achieved by providing a powder mixture according to claim 1, a method according to claim 8, a use according to claim 10, an article, in particular cookware and bakeware, according to claim 12 or 13. Preferred embodiments are set forth in the sub-claims. According to the invention, the term cooking and baking accessory comprises any article suitable in shape for holding food and subsequently cooking and baking. Therefore, in addition to pans, the above term also includes baking trays, baking molds, etc., as well as grill trays, grill containers, grill grates, etc.

In a first aspect according to the invention, a powder mixture is provided, dry or as a dispersion in a liquid, comprising powder particles of at least one polyaryletherketone (PAEK) polymer and optionally polyphenylene sulfide (PPS) polymer.

The powder mixture according to the invention can be produced without the addition of fluorine or fluorine-containing compounds. This is particularly the case according to the invention if the powder mixture does not exceed certain limit values of total fluoride after combustion at 900° C.-1000° C. in a humid, oxygen-rich atmosphere. Preferably, the powder mixture therefore comprises at most 1000 ppb, preferably at most 100 ppb, more preferably at most 25 ppb total fluorides, measured by combustion ion chromatography (TOF-CIC).

Specifically, to perform the combustion ion chromatography (TOF-CIC) measurement procedure according to the invention, samples of the powder mixture are filled into ceramic boats and introduced into a furnace where pyrohydrolysis takes place at 900-1000° C. in a humid, O₂-rich environment. The samples are oxidized under these conditions, the strong carbon-fluorine bond is broken, and the vapors are passed through an absorption solution containing Ar. The HF formed during the combustion of organic fluorine dissociates in the absorption solution to form H+ and F− ions. The samples of the absorption solution, which also contains an internal standard to calibrate the analytical results, are then transferred to an ion chromatograph for analysis, where fluoride is measured.

Surprisingly, the powder mixture according to the invention is particularly suitable for coating objects, especially cookware and bakeware. The non-stick effect (tested using standard pancakes according to DIN EN 60350-2) of the coating produced using the powder mixture according to the invention met the expectations of a non-stick effect for cookware without the addition of oil and without any fluorine components. In particular, when using the powder mixture according to the invention to produce the coating, no fluorosurfactant is required to promote leveling.

Another advantage is that only one, relatively thin layer is required to meet all the requirements of a non-stick coating for food contact. According to the state of the art, wear-resistant polytetrafluoroethylene (PTFE) coatings with 3 layers and a layer thickness of approx. 50-60 μm are currently common. With the present coating of approx. 20-30 μm, the use of materials, the use of volatile organic compounds (VOC) and the use of energy can be considerably reduced in addition to the complete avoidance of per- or polyfluorinated alkyl compounds (PFAS).

Preferably, the powder mixture comprises at least two polymers, wherein powder particles comprising the first polymer have a mass-related particle size distribution D50, measured by static image analysis according to ISO 13322-1:2014, which is at most 70 μm, preferably at most 60 μm, more preferably at most 50 μm, even more preferably at most 40 μm, in particular at most 30 μm, and powder particles comprising the second polymer have a mass-related particle size distribution D50, measured by static image analysis according to ISO 13322-1:2014, which is at most 30 μm, preferably 25 μm, more preferably at most 20 μm, even more preferably at most 15 μm, in particular preferably 10 μm. This can enhance the mechanical resistance. This was achieved by the addition of PEK and/or PEKK. Even smaller mass-related concentrations of the second polymer of at least 2 wt. %, preferably at least 5 wt. %, particularly preferably at least 10 wt. % showed a wear-reducing effect.

Conversely, by adding PPS in the range of up to 80 wt. %, 90 wt. %, or 95 wt. %, a further reduction in the baking temperature during the production of the coating and a further improvement in the non-stick effect of the resulting coating could be measured.

Preferably, the powder mixture is present as a dispersion and preferably the liquid in the dispersion comprises water.

Preferably, the powder mixture comprises at least two PAEK polymers, or at least one PAEK polymer and one PPS polymer, wherein the PAEK polymers are preferably selected from the group consisting of polyether ether ketone (PEEK), polyether ketone (PEK), polyether ketone ketone (PEKK) and polyether ketone ketone (PEKKEK). Preferably, the polymers have different melting temperatures and/or preferably different melt viscosities.

Preferably, the average melt viscosity of at least one polymer is at most 150 Pa·s, preferably at most 120, more preferably at most 100 Pa·s or in particular preferably at most 90 Pa·s, measured according to ISO 11443 at 400° C.. This results in a much smoother process when heated to polycondensation on a surface to be coated. The non-stick effect of the coated surface is thus improved. This even applies, if the particles are large relative to the coating thickness (e.g. 25 μm particle size D 50 for 25 μm coating thickness).

Preferably, the powder mixture also comprises an element from the group consisting of polyamideimides (PAI), polyimides (PI), graphite, MOS₂ and a mixture thereof. This can further improve the wear resistance.

In a second aspect according to the invention, a method for coating articles, in particular cookware and bakeware, is provided. The method comprises the following steps:
Applying the inventive powder mixture to the object, particularly to cookware and bakeware, wherein the application is preferably carried out electrostatically, by fluidized bed sintering, or as a dispersion in a liquid, particularly water;
In the case of dispersion, complete removal of the liquid;
heating the powder mixture to form a polycondensate; and
Baking the powder mixture above the melting temperature of the polymers.

Preferably, the baking temperature (substrate temperature) is at most 60° C., preferably at most 50° C., more preferably at most 40° C., still more preferably at most 30° C., in particular preferably at most 20° C. above the liquidus temperature of the polycondensate.

Experiments have shown that the non-stick effect improved as the baking temperature decreased, whereas excessively high baking temperatures resulted in poor performance.

Preferably, the method, particularly the step of heating the powder mixture to form a polycondensate, is carried out without the use of a fluorosurfactant.

In a third aspect of the invention, the use of the powder mixture for coating objects, particularly cookware and bakeware, to achieve a technical effect is provided. The technical effect is selected from the group consisting of: a non-stick effect, tested using standard pancakes (DIN EN 60350-2); electrical insulation of at least 1 V, preferably at least 2 V, more preferably at least 3 V, even more preferably at least 4 V, and particularly preferably at least 5 V, measured in a 5% saline solution on the coated inner surface of the object, particularly cookware and bakeware; ensuring sufficient corrosion protection of the metallic substrate of the object, particularly cookware and bakeware; or a combination thereof.

In a fourth aspect of the invention, an object, particularly cookware and bakeware, having a coating produced according to the method of the second aspect of the invention, is provided. Preferably, the average thickness of the coating is at most 50 μm, preferably at most 40 μm, more preferably at most 25 μm, and particularly preferably at most 25 μm.

In the following, the invention is explained in more detail with reference to examples of embodiments and the associated Figures.

The Figures are solely for a better understanding of the invention and are presented schematically and not to scale.

The invention is not intended to be limited to the exemplary embodiments. Identical or functionally equivalent parts are marked with the same reference signs.

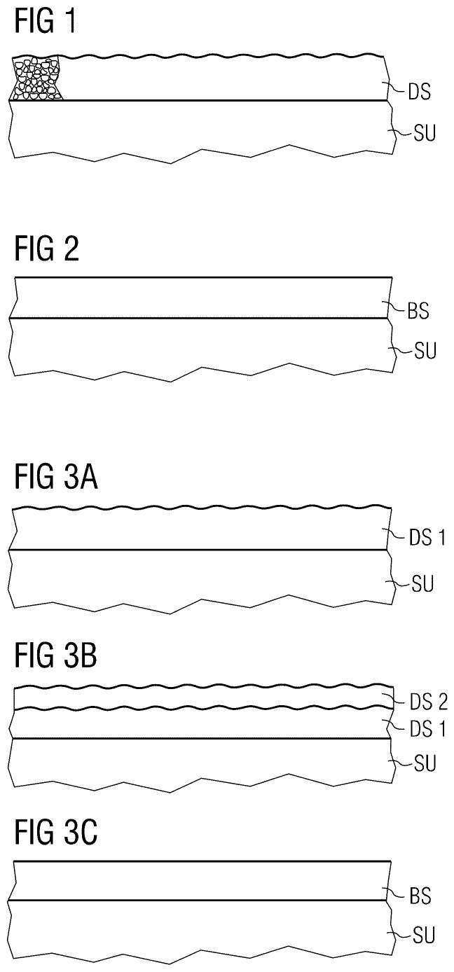

FIG. 1 shows a schematic cross-section of cookware and bakeware with an applied dispersion layer,

FIG. 2 shows cookware and bakeware with a coating according to the invention,

FIG. 3 shows a process sequence for coating using various process stages,

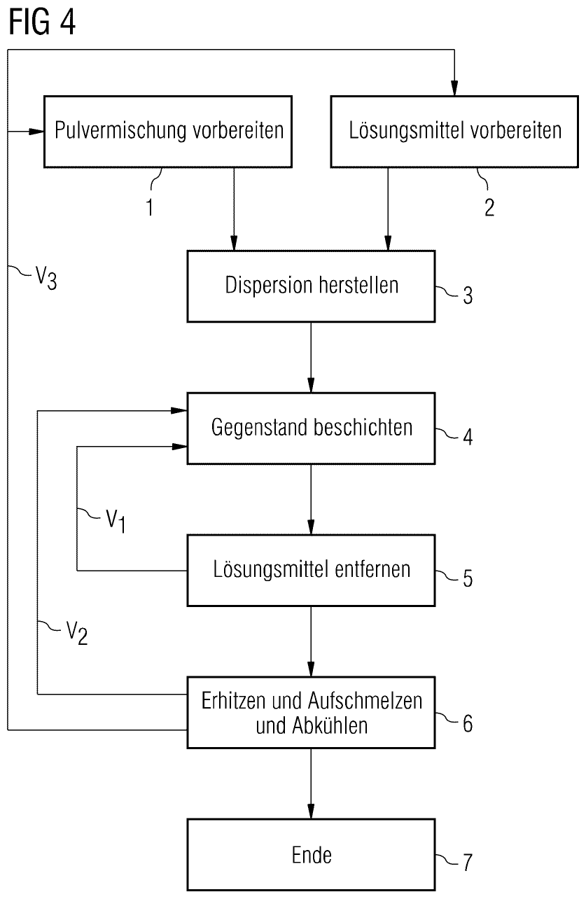

FIG. 4 shows a flow chart for a coating using a dispersion process.

An object to be coated or an area of the cooking and baking accessory to be coated represents the substrate SU to be coated. The surface to be coated can first be subjected to a chemical and/or mechanical activation treatment. For this purpose, mechanical roughening, for example by means of a sandblasting fan, or etching with acids, alkalis or a plasma or laser treatment can be used. An appropriately pre-treated surface has additional chemical/physical bonding points, is clean and grease-free and, in the case of roughening, has a larger surface area, which leads to better adhesion of the coating to be applied.

A layer DS of a dispersion is then applied to this surface, which, dispersed in a solvent or solvent mixture, contains all the components of the coating in a finely divided and preferably homogeneous particle size distribution. An application method is selected which is suitable for producing the desired coating thickness. The average particle size (D50) of the solids contained in the dispersion corresponds at most to the desired layer thickness for the coating, but is preferably smaller. FIG. 1 shows a substrate SU coated in this way with an applied dispersion layer DS.

After executing a temperature program, during which the substrate or the cookware and bakeware provided with the dispersion layer (DS) is heated to a temperature above the melting point of the thermoplast(s) contained in the dispersion, a homogeneous coating (BS) is obtained, which is pore-free and thus dense, exhibiting good mechanical cohesion as well as strong adhesion to the substrate (SU). FIG. 2 shows the finished cookware and bakeware.

It is possible to apply the coating to only part of the surface. The remaining area that is not to be coated can be covered or an application method for the dispersion can be selected that can differentiate between different surface areas, for example brushing or printing. The covering can also be done with a shadow mask during the spraying of the dispersion. This shadow mask can also take the form of a film that is applied to the surface of the substrate SU and leaves out the areas of the surface to be coated. After the dispersion layer DS has been applied, the film can be removed and peeled off, for example, whereby the areas of the dispersion layer DS applied on top of it are also peeled off.

FIG. 3 shows a variant of the process with which a higher layer thickness can still be achieved despite a smaller selected particle diameter of the solids contained in the dispersion. For this purpose, after the application of the first dispersion layer DS1, as shown in FIG. 3a, at least the solvent is removed, or alternatively the first dispersion layer is also pre-compacted accordingly by means of a temperature treatment. In a second step, the dispersion coating is repeated and a second dispersion layer DS2 is applied. If necessary, this layer can also be pre-compacted and the coating step repeated again. Finally, as shown in FIG. 3c, the structure of dispersion layers consisting of several partial layers is brought to a temperature above the melting point of the thermoplastic in a final step, whereby a fully compacted, pore-free, closed coating BS is obtained on the substrate SU.

A composition suitable for application by means of a dispersion process and also friction-reduced according to the invention contains, for example, solids in the following proportions by weight:

100 percent PEEK by weight

Color additives can be added if necessary. It is possible to apply one or more coats.

If necessary, the solids are dispersed with auxiliary agents in a solvent, which may be water or is advantageously miscible or mixed with water, e.g. alcohol and in particular isopropanol. The dispersion mixture then contains approx. 30% by weight of the above-mentioned solids.

FIG. 4 illustrates the process sequence just described more clearly using a flow chart. Step 1 of the process comprises the production and preparation of the powder mixture. For this purpose, the ingredients, which are selected from thermoplastic polymer, filler and dry lubricant, are either brought to a suitable particle size, preferably by grinding and/or by subsequent sorting according to particle size in accordance with a desired particle size distribution that is as narrow as possible.

Parallel to this, the solvent is prepared in step 2, which is preferably harmless to the environment and health, preferably on an aqueous basis and in particular consists of a mixture of alcohol and water, e.g. isopropanol and water. An advantageous solvent composition contains, for example, 25 to 75 percent by weight of isopropanol in water. Particularly preferred is a solvent with about 25-50 percent by weight of isopropanol in water.

In step 3, the dispersion is produced by adding the solvent to the prepared powder mixture, preferably with a solids content of 20 to 50 percent by weight. To improve the dispersion stability, small amounts of known dispersion aids can be added.

In step 4, the surface of the object is coated, for example by spraying, dipping, brushing, printing or spinning. The aim here is to achieve as homogeneous a layer thickness of the dispersion layer as possible and, if necessary, areas of the surface that are not to be coated are left out of the coating.

In step 5, the solvent is removed, preferably by evaporation, which can be assisted by negative pressure or increased temperature, for example 80° C., if necessary.

In the next step 6, the cookware and bakeware with the applied dried dispersion layer are converted into a homogeneous coating by heating and melting the thermoplastics and then the cookware and bakeware are cooled again.

Following this step 6, a finished coating can be obtained at point 7.

According to a variant V1 of the method, it is possible to carry out steps 4 to 7 again directly after step 5.

A second variant V2 follows step 6, whereby a new dispersion layer is applied after the first dispersion layer has been melted (step 4) and compacted accordingly (steps 5 to 7).

According to a third variant V3 of the method, after a first coating has been produced according to step 6, a second partial layer of the coating, different from the first coating, is applied. For this purpose, a further dispersion is produced according to process steps 1 to 3 and the cookware and bakeware are coated with it according to steps 4 to 6. Here too, the process according to variants V1 and V2 can be modified by repeating individual process steps or individual process step sequences in order to achieve a desired coating thickness.

Especially when using finely divided particles for the dispersion, a particularly homogeneous coating can be obtained, which makes multiple coating advantageous or necessary due to the small particle diameters.

Although the invention has only been explained with reference to a few embodiments, it is not limited to these. Possible variations result in particular from a suitable selection of fillers and, if necessary, from mixtures of different fillers. The proportions of the coating components used are selected depending on the desired load on the coating. The same applies to the coating thicknesses, which are not limited to the examples given. Advantageously, the coating is applied to metallic surfaces, although the coating can also be applied to other surfaces such as ceramics, glass or suitable plastic.

### EXAMPLES

A pan coating was produced as follows: An aqueous dispersion with a solvent content of 25% and a solids content of 30% was prepared. The solid material consisted of PEEK from Victrex with a mean mass-related grain diameter D50 of 10 μm and a specified mean melt viscosity, measured according to ISO 11443 at 400° C., of 150 Pa·s (120-180 Pa·s). The substrate in the form of an aluminum pan was cleaned and degreased and then blasted. The Rz after blasting was approx. 20 μm (measured by scanning or non-contact optical roughness measurement). The aqueous PEEK dispersion was sprayed on with conventional spray guns, dried at approx. 50° C. and then baked at 400° C. oven temperature. This resulted in an optically closed, pore-free surface with a roughness of approx. Rz 20 μm (measured by scanning or non-contact optical roughness measurement).

However, in the migration tests subsequently carried out to verify compliance with the legal limits, it was found that the prescribed limits could not be met because the coating was too thin to sufficiently cover the metal substrate. In subsequent tests, the curing temperature was increased in order to improve the process due to the resulting decrease in melt viscosity. Surprisingly, it was found that the non-stick effect decreased with increasing baking temperature. Conversely, the non-stick effect was improved by reducing the baking temperature.

Surprisingly, another experiment showed that the addition of a PEEK type with a lower melt viscosity of 90 Pa·s, even with a particle size D 50 of 25 μm-equivalent to the target layer thickness-resulted in a smoother, defect-free flow and an improved non-stick effect. In particular, the baking temperature could be reduced by 30° C., lowering the oven temperature to 370° C. and the maximum substrate temperature to 360° C.

The non-stick effect was tested using standard pancakes (DIN EN 60350-2). The non-stick effect of the coating produced in this way met the expectations of a non-stick effect for cookware without the addition of oil and without any fluorine components. In particular, the inventive coating does not require any fluorosurfactant to promote flow.

Another advantage is that only one, relatively thin layer is required to meet all the requirements of a non-stick coating for food contact. According to the state of the art, wear-resistant PTFE coatings are currently 3-layered with a layer thickness of approx. 50-60 μm. With the present coating of approx. 20-30 μm, the use of material, VOC and energy can be considerably reduced in addition to the complete avoidance of PFAS

In a further test, the mechanical resistance was to be increased. This was achieved by adding PEK and/or PEKK. Even smaller concentrations of 10, 5 or 2 % showed a wear-reducing effect.

By adding an element from the group consisting of polyamidimides (PAI), polyimides (PI), graphite, MoS₂ and a mixture of these, the wear resistance could be further improved.

Conversely, the addition of PPS in the order of up to 80, 90 and 95 % led to a further reduction in the baking temperature and a further improvement in the non-stick effect.

During the tests, it came as a complete surprise that the melting temperature was shifted upwards by mixing different types of polymer after baking. This ensures that the coating of a pan does not become liquid. A pan can reach a surface temperature of over 300° C. during use, whereas the melting temperature of the coating of a reference pan is 340° C., for example. And not according to the concentration between the two temperatures of 2 polymers involved, but even to that of the higher melting polymer or even higher. In particular, it was measured that a coating according to the invention, consisting of PEEK and PEK, did not become liquid up to 400° C. and above. However, even a coating consisting of PEEK and PPS, where the concentration of PPS was 90%, did not become liquid up to 380° C., although the melting points of the individual polymers are 285 and 340° C.

1. A powder mixture, dry or as a dispersion in a liquid, comprising powder particles of at least one polyaryletherketone (PAEK) polymer and optionally polyphenylene sulfide (PPS) polymer, wherein the powder mixture can be prepared without the addition of fluorine or fluorine-containing compounds.

2. The powder mixture according to claim 1, wherein the powder mixture comprises at most 1000 ppb, preferably at most 100 ppb, more preferably at most 25 ppb total fluorides measured by combustion ion chromatography (TOF-CIC).

3. Powder mixture according to claim 1 or 2, wherein the powder mixture comprises at least two polymers, and wherein powder particles comprising the first polymer have a mass-related particle size distribution D50, measured by static image analysis according to ISO 13322-1:2014, which is at most 70 μm, preferably at most 60 μm, more preferably at most 50 μm, still more preferably at most 40 μm, in particular at most 30 μm, and powder particles comprising the second polymer have a mass-related particle size distribution D50, measured by static image analysis according to ISO 13322-1:2014, which is at most 30 μm, preferably 25 μm, more preferably at most 20 μm, still more preferably at most 15 μm, in particular preferably 10 μm.

4. The powder mixture according to any one of the preceding claims, wherein the powder mixture is present as a dispersion and the liquid comprises water.

5. The powder mixture according to any one of the preceding claims, wherein the powder mixture comprises at least two PAEK polymers, or at least one PAEK polymer and PPS polymer, wherein the PAEK polymers are preferably selected from the group consisting of polyether ether ketone (PEEK), polyether ketone ketone (PEK), polyether ketone ketone (PEKK) and polyether ketone ketone ketone (PEKKEK).

6. The powder mixture according to claim 5, wherein the polymers have different melting temperatures.

7. The powder mixture according to claim 5 or 6, wherein the PAEK polymers have different melt viscosities, measured according to ISO 11443 at 400° C.

8. Powder mixture according to any one of the preceding claims, wherein the average melt viscosity of at least one polymer is at most 150 Pa·s, preferably at most 120, more preferably at most 100 Pa·s or in particular preferably at most 90 Pa·s, measured according to ISO 11443 at 400° C.

9. The powder mixture according to any one of the preceding claims, wherein the powder mixture further comprises an element selected from the group consisting of polyamideimides (PAI), polyimides (PI), graphite, MoS2 and a mixture thereof.

10. Process for coating an article, in particular cookware and bakeware, comprising the following steps:
Applying the powder mixture according to any one of claims 1 to 9 to the article, in particular cookware and bakeware, wherein the application is preferably carried out electrostatically, by the fluidized bed method or as a dispersion in liquid, in particular water;
In the case of dispersion, complete removal of the liquid;
heating the powder mixture to form a polycondensate; and
Baking the powder mixture above the melting temperature of the polymers.

11. Process according to claim 10, wherein the baking temperature (substrate temperature) is at most 60° C., preferably at most 50° C., more preferably at most 40° C., still more preferably at most 30° C., in particular preferably at most 20° C. above the liquidus temperature of the polycondensate.

12. The process according to claim 10 or 11, wherein the process is carried out without using a fluorosurfactant, in particular in the step of heating the powder mixture to form a polycondensate.

13. Use of the powder mixture according to one of claims 1 to 9 for coating an object, in particular cookware and bakeware, to achieve a technical effect selected from the group consisting of non-stick effect, tested by means of standard pancakes (DIN EN 60350-2), electrical insulation of at least 1 V, preferably at least 2V, more preferably at least 3V, even more preferably at least 4V, in particular preferably at least 5V, measured in 5% saline solution of the coated inner surface of the article, in particular cookware and bakeware, to ensure sufficient corrosion protection of the metallic substrate of the article, in particular cookware and bakeware, and a combination thereof.

14. An article, in particular cookware and bakeware, having a coating produced by the method according to any one of claims 10 to 12.

15. Article, in particular cookware and bakeware, according to claim 14, wherein the thickness of the coating is at most 50 μm, preferably at most 40 μm, more preferably at most 30 μm, in particular preferably at most 25 μm.
